(19) United States
(12) Patent Application Publication
(10) Pub. No.: US 2007/0273722 A1
(43) Pub. Date: Nov. 29, 2007

(54) Image recording method and image recording apparatus

(75) Inventors: Katsuto Sumi, Minami-ashigara-shi (JP); Issei Suzuki, Odawara-shi (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: FUJIFILM CORPORATION, Tokyo (JP)

(21) Appl. No.: 11/802,536

(22) Filed: May 23, 2007

(30) Foreign Application Priority Data
May 24, 2006 (JP) NO. 2006-143725

(51) Int. Cl. B41J 29/38

(52) U.S. Cl. 347/14

(57) ABSTRACT

Rectangular patterns are recorded on a substrate along a direction in which the substrate is moved and a direction perpendicular to the direction. Line widths of the rectangular patterns are measured, and mask data are established for obtaining amounts of light to correct changes in the line widths. When exposure heads are energized to record an image on the substrate by way of exposure, the mask data depending on a moved position of the substrate are read from a mask data memory, and applied to correct the output data for thereby recording a desired locality-free image on the substrate.

### BACKGROUND OF THE INVENTION

1. Field of the Invention

The present invention relates to a method of and an apparatus for recording an image on an image recording medium while a plurality of recording elements controlled depending on image data are being moved relatively to the image recording medium.

2. Description of the Related Art

FIG. 26 of the accompanying drawings is a view illustrative of a process of manufacturing a printed wiring board. As shown in FIG. 26, a substrate 2 with a copper foil 1 deposited thereon by evaporation or the like is prepared. A photoresist 3 made of a photosensitive material is pressed with heat against (laminated on) the copper foil 1. After the photoresist 3 is exposed to light according to a wiring pattern by an exposure apparatus, the photoresist 3 is developed by a developing solution. Then, the portion of the photoresist 3 which has not been exposed is removed. The copper foil 1 that is exposed by the removal of the photoresist 3 is etched away by an etching solution. Thereafter, the remaining photoresist 3 is peeled off by a peeling solution. As a result, a printed wiring board having the copper foil 1 left in the desired wiring pattern on the substrate 2 is manufactured.

There has been developed an apparatus using a spatial light modulator such as a digital micromirror device (DMD) or the like, for example, as the exposure apparatus for recording the wiring pattern on the photoresist 3 (see Japanese Laid-Open Patent Publication No. 2005-41105). The DMD comprises a number of micromirrors tiltably disposed in a matrix pattern on SRAM cells (memory cells). The micromirrors have respective reflecting surfaces with a highly reflective material such as aluminum or the like being deposited thereon. When a digital signal representative of image data is written into SRAM cells, the corresponding micromirrors are tilted in a given direction depending on the digital signal, selectively turning on and off light beams and directing the turned-on light beams to the photoresist.

In the exposure apparatus disclosed in Japanese Laid-Open Patent Publication No. 2005-41105, the substrate 2 with the laminated photoresist 3 is moved in a direction, and a plurality of exposure heads having DMDs arrayed in a direction perpendicularly to the direction in which the laminated photoresist 3 is moved guide light beams to the substrate 2 for thereby quickly recording a highly fine two-dimensional wiring pattern on the substrate 2 by way of exposure.

If the temperature of a light source for emitting the light beams at the time the exposure process of the exposure apparatus begins and the temperature of the light source at the time the exposure process ends are different from each other, then the amount of light of the light beams emitted from the light source tends to vary with time, possibly resulting in an exposure irregularity due to the variation of the amount of light along the direction in which the substrate 2 is moved.

The substrate 2 is placed on a movable stage, which transfers heat to the substrate 2 to heat the substrate 2. Since a certain time is required until the heat is transferred from the movable stage to the substrate 2, the temperature of the surface of the substrate 2 placed on the movable stage at the time the exposure process begins and the temperature of the surface of the substrate 2 placed on the movable stage at the time the exposure process ends are different from each other. Because the sensitivity of the photoresist 3 varies due to the above temperature variation, the wiring pattern formed along the direction in which the substrate 2 is moved is liable to suffer irregularities.

When the movable stage with the substrate 2 placed thereon moves, the distance between the exposure heads and the substrate 2 varies. At this time, the diameters of the light beams guided to the substrate 2 also vary, tending to result in irregularities of the wiring pattern formed along the direction in which the substrate 2 is moved.

Furthermore, if the developing process performed on the exposed substrate 2 by a developing apparatus suffers irregularities caused by the developing apparatus, then those irregularities appear as irregularities of the wiring pattern.

### SUMMARY OF THE INVENTION

It is a general object of the present invention to provide a method of and an apparatus for recording a desired image highly accurately on an image recording medium by correcting localities that appear along the direction in which recording elements move with respect to the image recording medium.

A major object of the present invention is to provide a method of and an apparatus for recording a desired image highly accurately on the entire two-dimensional surface of an image recording medium.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a perspective view of an exposure apparatus according to an embodiment of the present invention;

FIG. 2 is a schematic view of an exposure head of the exposure apparatus according to the embodiment;

FIG. 3 is an enlarged fragmentary view showing a digital micromirror device (DMD) employed in the exposure head shown in FIG. 2;

FIG. 4 is a view illustrative of an exposure recording process performed by the exposure head shown in FIG. 2;

FIG. 5 is a diagram showing the DMD of the exposure head shown in FIG. 2 and mask data set in the DMD;

FIG. 6 is a diagram showing the relationship between a recording position and an amount-of-light locality in the exposure apparatus according to the embodiment;

FIG. 7 is a diagram showing a line width recorded when the amount-of-light locality shown in FIG. 6 is not corrected;

FIG. 8 is a diagram showing a line width recorded when the amount-of-light locality shown in FIG. 6 is corrected;

FIG. 9 is a block diagram of a control circuit of the exposure apparatus according to the embodiment;

FIG. 10 is a flowchart of a process of setting mask data which is performed by the exposure apparatus according to the embodiment;

FIG. 11 is a diagram showing a test pattern composed of rectangular patterns recorded on a substrate by the exposure apparatus according to the embodiment;

FIG. 12 is a diagram showing the relationship between the positions of the rectangular patterns shown in FIG. 11 and measured line widths;

FIG. 13 is a diagram showing the relationship between changes in the amount of light of a laser beam applied to the substrate and corresponding line width changes;

FIG. 14 is a diagram showing the relationship between the position of the substrate and the amount-of-light correction variables;

FIG. 15 is a flowchart of an exposure recording process performed by the exposure apparatus according to the embodiment;

FIG. 16 is a diagram illustrative of a halftone dot pattern recorded on a substrate by the exposure apparatus according to the embodiment;

FIG. 17 is a diagram illustrative of grayscale data as test data;

FIG. 18 is a diagram illustrative of a copper foil pattern formed on a substrate using the grayscale data shown in FIG. 17;

FIG. 19 is a diagram illustrative of a grid-like pattern recorded on a substrate by the exposure apparatus according to the embodiment;

FIG. 20 is a view showing an edge area formed along a direction in which a substrate is scanned;

FIG. 21 is a view showing an edge area formed along a direction perpendicular to a direction in which a substrate is scanned;

FIG. 22 is a diagram showing the relationship between changes in the amount of light and corresponding line widths on photosensitive materials of different types;

FIG. 23 is a diagram showing the relationship between the position of the substrate and the line width on photosensitive materials of different types;

FIG. 24 is a diagram showing the relationship between the position of the substrate and the amount-of-light correction variables on photosensitive materials of different types;

FIG. 25 is a diagram illustrative of areas into which the DMD of the exposure apparatus according to the embodiment is divided; and

FIG. 26 is a view illustrative of a process of manufacturing a printed wiring board.

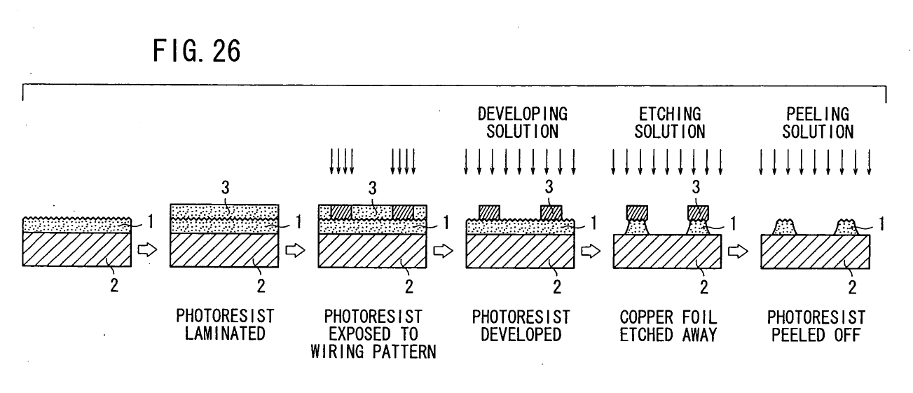

### DESCRIPTION OF THE PREFERRED EMBODIMENT

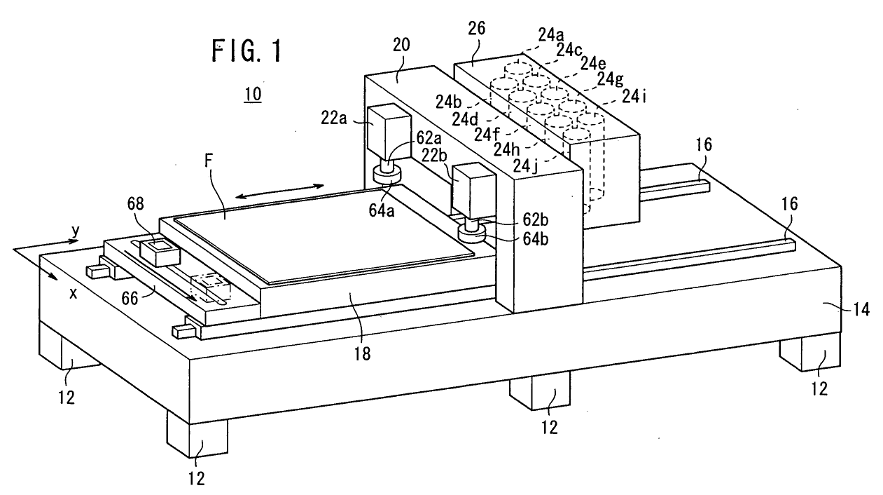

FIG. 1 shows in perspective an exposure apparatus 10 for performing an exposure process on a printed wiring board, to which an image recording method and an image recording apparatus according to an embodiment of the present invention are applied. As shown in FIG. 1, the exposure apparatus 10 has a bed 14, which is essentially free of deformations, supported by a plurality of legs 12, and an exposure stage 18 mounted on the bed 14 by two parallel guide rails 16 for reciprocating movement in the directions indicated by the arrow. An elongate rectangular substrate F (image recording medium) coated with a photosensitive material is attracted to and held on the exposure stage 18.

A portal column 20 is mounted centrally on the bed 14 over the guide rails 16. Two CCD cameras 22a, 22b are fixed to one side of the column 20 for detecting the position in which the substrate F is mounted with respect to the exposure stage 18. A scanner 26 having a plurality of exposure heads 24a through 24j positioned and held therein for recording an image on the substrate F by way of exposure is fixed to the other side of the column 20. The exposure heads 24a through 24j are arranged in two staggered rows in a direction perpendicular to the directions in which the substrate F is scanned, i.e., the directions in which the exposure stage 18 is movable. Flash lamps 64a, 64b are mounted on the CCD cameras 22a, 22b, respectively, by respective rod lenses 62a, 62b. The flash lamps 64a, 64b apply an infrared radiation to which the substrate F is insensitive, as illuminating light, to an image capturing area for the CCD cameras 22a, 22b.

A guide table 66 which extends in the direction perpendicular to the directions in which the exposure stage 18 is movable is mounted on an end of the bed 14. The guide table 66 supports thereon a photosensor 68 movable in the direction indicated by the arrow x for detecting the amount of light of laser beams L emitted from the exposure heads 24a through 24j.

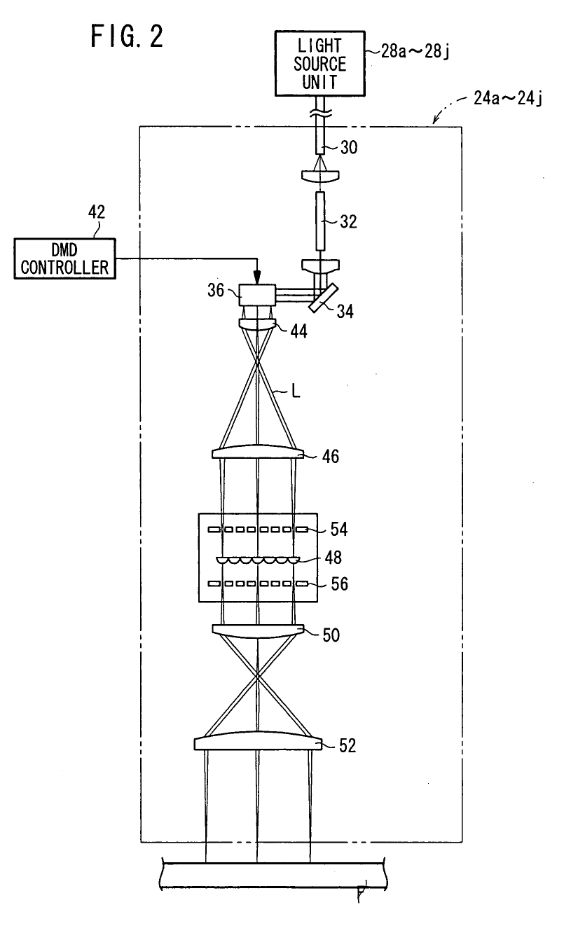

FIG. 2 shows a structure of each of the exposure heads 24a through 24j. A combined laser beam L emitted from a plurality of semiconductor lasers of light source units 28a through 28j connected to the respective exposure heads 24a through 24j is introduced through an optical fiber 30 into each of the exposure heads 24a through 24j. A rod lens 32, a reflecting mirror 34, and a digital micromirror device (DMD) 36 (exposure device) are successively arranged on an exit end of the optical fiber 30 into which the laser beam L is introduced.

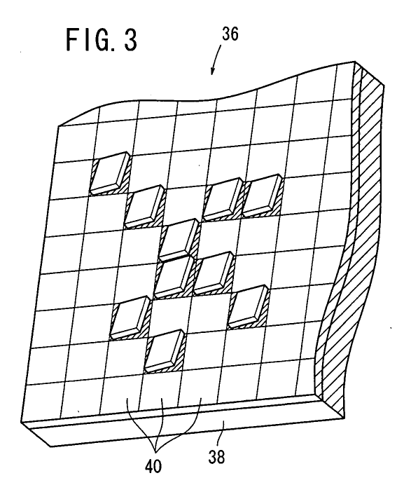

As shown in FIG. 3, the DMD 36 comprises a number of micromirrors 40 (recording elements) that are tiltably disposed in a matrix pattern on SRAM cells (memory cells) 38. A material having a high reflectance such as aluminum or the like is evaporated on the surface of each of the micromirrors 40. When a digital signal according to image recording data is written in the SRAM cells 38 by a DMD controller 42, the micromirrors 40 are tilted in given directions depending on the applied digital signal. Depending on how the micromirrors 40 are tilted, the laser beam L is turned on or off.

In the direction in which the laser beam L reflected by the DMD 36 that is controlled to be turned on or off is emitted, there are successively disposed first image focusing optical lenses 44, 46 of a magnifying optical system, a microlens array 48 having many lenses corresponding to the respective micromirrors 40 of the DMD 36, and second image focusing optical lenses 50, 52 of a zooming optical system. Microaperture arrays 54, 56 for removing stray light and adjusting the laser beam L to a predetermined diameter are disposed in front of and behind the microlens array 48.

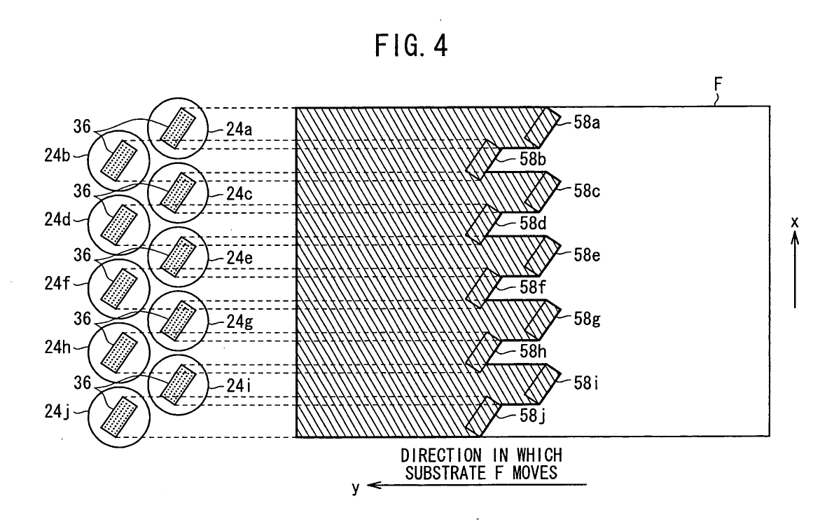

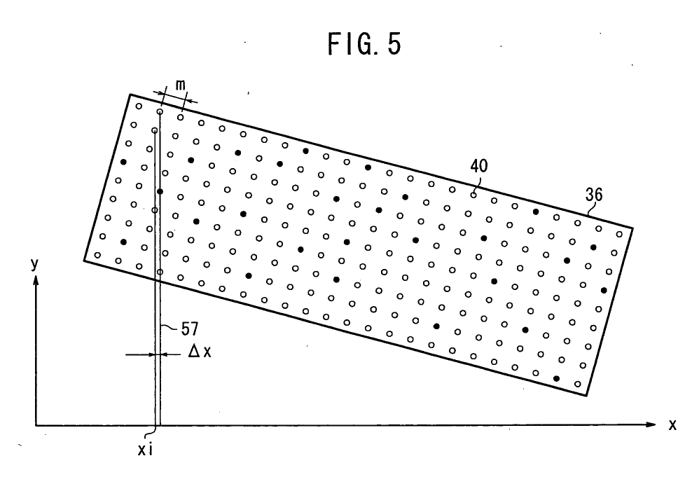

As shown in FIGS. 4 and 5, the DMDs 36 incorporated in the respective exposure heads 24a through 24j are inclined a predetermined angle to the direction in which the exposure heads 24a through 24j scan the substrate F, for achieving higher resolution. Specifically, the DMDs 36 that are inclined to the direction in which the substrate F moves reduce the interval Δx between the micromirrors 40 in the direction, i.e., the direction indicated by the arrow X, perpendicular to the direction in which the substrate F moves, to a value smaller than the interval m between the micromirrors 40 in the direction in which they are arrayed, thereby increasing the resolution in the direction indicated by the arrow X.

In FIG. 5, a plurality of micromirrors 40 are disposed on one scanning line 57 in the scanning direction of the DMDs 36. The substrate F is exposed to a multiplicity of images of one pixel by laser beams L that are guided to substantially the same position by these micromirrors 40. In this manner, amount-of-light irregularities between the micromirrors 40 can be averaged. To make the exposure heads 24a through 24j seamless, they are arranged such that exposure areas 58a through 58j which are exposed at a time by the respective exposure heads 24a through 24j overlap in the direction indicated by arrow x (see FIG. 4).

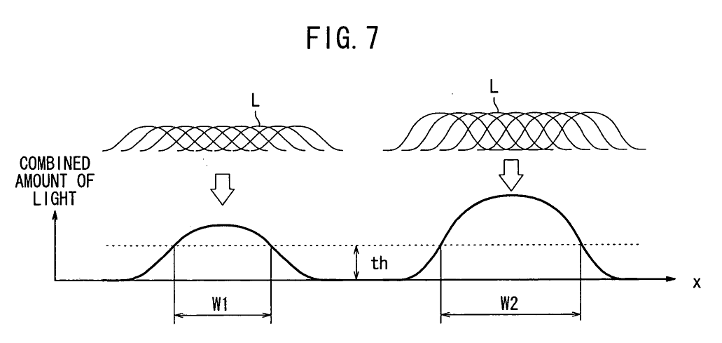

The amount of light of the laser beam L that is guided to the substrate F by each of the micromirrors 40 of the DMDs 36 has a locality caused by the micromirrors 40 of the DMDs 36 along the direction indicated by the arrow x in which the exposure heads 24a through 24j are arrayed, and the state of the optical systems. With such a locality, as shown in FIG. 7, when an image is recorded on the substrate F by laser beams L having a smaller combined amount of light which are reflected by a plurality of micromirrors 40 and when an image is recorded on the substrate F by laser beams L having a greater combined amount of light which are reflected by the micromirrors 40, the images have respective widths W1, W2 in the direction indicated by the arrow x which are determined by a threshold th beyond which the photosensitive material applied to the substrate F is sensitive to the laser beams L. These widths W1, W2 are different from each other depending on the exposed position in the direction indicated by the arrow x. When the exposed substrate F is processed by a developing process, an etching process, and a peeling process, the widths of the images are also varied by photoresist lamination irregularities, developing process irregularities, etching process irregularities, and peeling process irregularities as well as the locality of the amount of light of the laser beams L in the direction indicated by the arrow x.

The widths of the images may also be varied depending on not only the exposed position in the direction indicated by the arrow x, but also the exposed position in the direction in which the substrate F moves, i.e., the direction indicated by the arrow y.

For example, the temperature of each of the semiconductor lasers of the light source units 28a through 28j rises after the semiconductor laser has started emitting the laser beam L until its laser beam emission ends. Because of the temperature rise, the amount of light of the laser beam L emitted from the semiconductor laser increases gradually during the laser beam emission. Furthermore, if the temperature of the surface of the substrate F at the time the substrate F is placed on the exposure stage 18 and starts being exposed is different from the temperature of the surface of the substrate F at the time the exposure of the substrate F ends, then the photosensitivity of the photosensitive material applied to the substrate F varies during the exposure. If the distance between the exposure heads 24a through 24j and the substrate F varies upon movement of the exposure stage 18 in the direction indicated by the arrow y, the diameter on the substrate F of each of the laser beams L that are guided to the substrate F varies, resulting in variations of the dot size of an image recorded on the substrate F. Moreover, when a processing apparatus for performing a developing process, an etching process, and a peeling process on the exposed substrate F operates while the exposed substrate F is moving in the direction indicated by the arrow x, the processing apparatus produces processing irregularities in the direction indicated by the arrow y. All the irregularities described above are liable to vary the width of the image depending on the exposed position on the substrate F in the direction indicated by the arrow y.

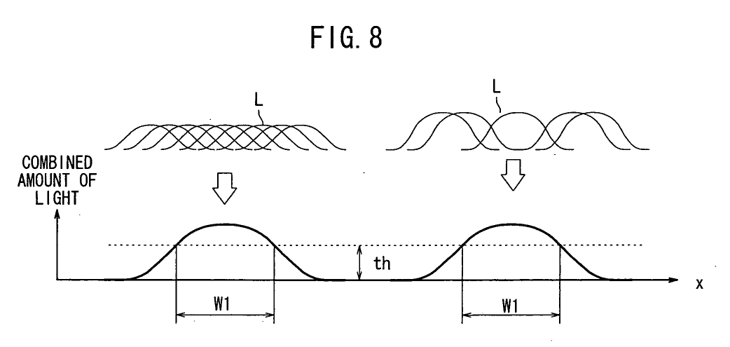

According to the present embodiment, in view of the above image width varying irregularities, the number of micromirrors 40 that are used to form one pixel of image on the substrate F is set and controlled using mask data for producing images having a constant width W1, as shown in FIG. 8, regardless of the exposed positions in the directions indicated by the arrows x, y after the images are produced through the various processes including the final peeling process.

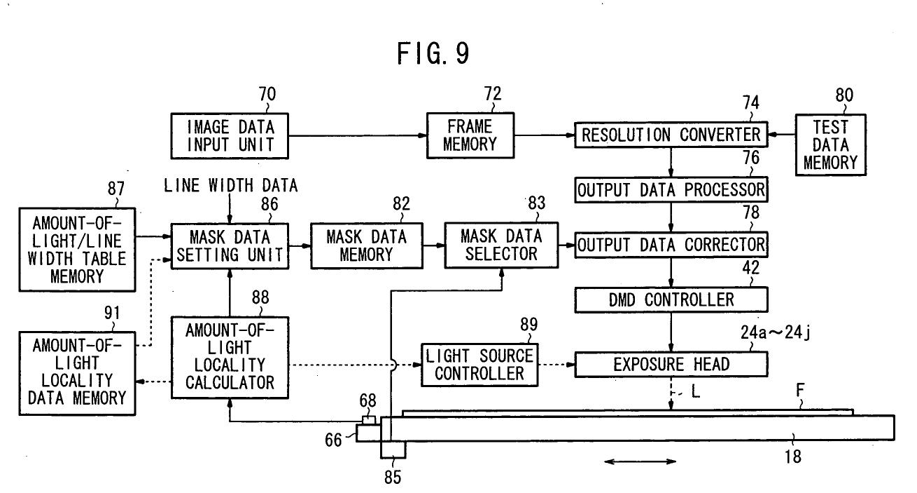

FIG. 9 shows in block form a control circuit of the exposure apparatus 10 for performing a control process to produce such images having a constant width.

As shown in FIG. 9, the exposure apparatus 10 has an image data input unit 70 for entering two-dimensional image data to be recorded on the substrate F by way of exposure, a frame memory 72 for storing the two-dimensional image data entered by the image data input unit 70, a resolution converter 74 for converting the resolution of the image data stored in the frame memory 72 into a higher resolution depending on the size and layout of the micromirrors 40 of the DMDs 36 of the exposure heads 24a through 24j, an output data processor 76 for processing the resolution-converted image data into output data to be assigned to the micromirrors 40, an output data corrector 78 for correcting the output data according to mask data, a DMD controller 42 (recording element controller) for controlling the DMDs 36 according to the corrected output data, and the exposure heads 24a through 24j for recording, by way of exposure, a desired image on the substrate F with the DMDs 36 that are controlled by the DMD controller 42.

A test data memory 80 (test data storage unit) for storing test data is connected to the resolution converter 74. The test data are data for recording a test pattern on the substrate F by way of exposure and generating mask data based on the test pattern.

A mask data memory 82 (mask data storage unit) is connected to the output data corrector 78 through a mask data selector 83. The mask data selector 83 selects mask data depending on the position, detected by an encoder 85, to which the exposure stage 18 has moved in the direction indicated by the arrow y, and supplies the selected mask data to the output data corrector 78.

The mask data are data for specifying micromirrors 40 to be turned off in order to correct a locality depending on each position to which the substrate F has moved. The mask data are set by a mask data setting unit (mask data establishing unit) 86. The mask data setting unit 86 sets mask data using line width data which are acquired by measuring the test pattern and a table read from an amount-of-light/line width table memory 87. The amount-of-light/line width table memory 87 stores a table representative of the relationship between amounts of light of the laser beams L and line widths, as established according to the characteristics of the photosensitive material.

The exposure apparatus 10 also has an amount-of-light locality calculator 88 for calculating amount-of-light locality data with respect to the direction indicated by the arrow x, based on the amounts of light of the laser beams L detected by the photosensor 68. The amount-of-light locality data calculated by the amount-of-light locality calculator 88 are supplied to the mask data setting unit 86 to set initial mask data.

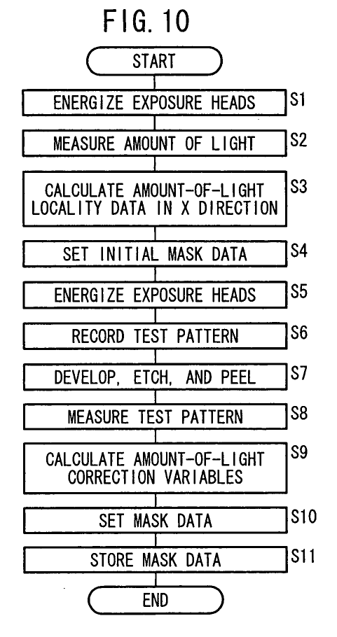

The exposure apparatus 10 according to the present embodiment is basically constructed as described above. A process of setting mask data which is performed by the exposure apparatus 10 will be described below with reference to FIG. 10.

First, the exposure stage 18 is moved to place the photosensor 68 beneath the exposure heads 24a through 24j. Thereafter, the exposure heads 24a through 24j are energized (step S1). At this time, the DMD controller 42 sets all the micromirrors 40 of the DMDs 36 to an on-state for guiding the laser beams L to the photosensor 68.

While moving in the direction indicated by the arrow x in FIG. 1, the photosensor 68 measures the amounts of light of the laser beams L emitted from the exposure heads 24a through 24j, and supplies the measured amounts of light to the amount-of-light locality calculator 88 (step S2). Based on the measured amounts of light, the amount-of-light locality calculator 88 calculates amount-of-light locality data of the laser beam L at each position xi in the direction indicated by the arrow x, and supplies the calculated amount-of-light locality data to the mask data setting unit 86 (step S3).

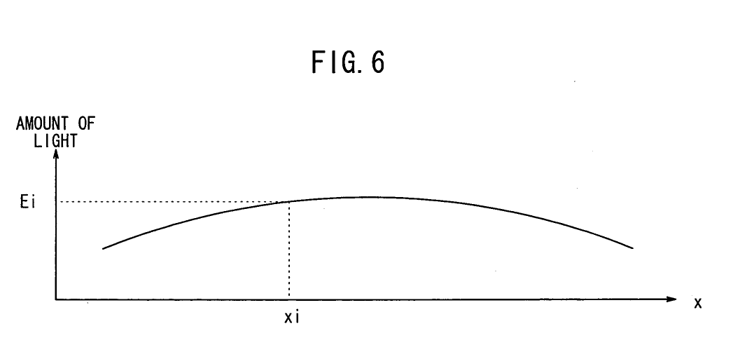

Based on the supplied amount-of-light locality data, the mask data setting unit 86 generates initial mask data for making constant the amount Ei of light of the laser beam L at each position xi on the substrate F, and stores the initial mask data in the mask data memory 82 (step S4). The initial mask data are established as data for securing some of a plurality of micromirrors 40 for forming one image pixel at each position xi on the substrate F, to an off-state according to the amount-of-light locality data in order to eliminate the amount-of-light locality shown in FIG. 6, for example. In FIG. 5, those micromirrors 40 that have been set to the off-state by the initial mask data are illustrated as black dots.

After the initial mask data have been established, the exposure heads 24a through 24j are energized based on test data and the exposure stage 18 is moved in the direction indicated by the arrow y (step S5).

The resolution converter 74 reads test data from the test data memory 80, converts the resolution of the test data into a resolution corresponding to the micromirrors 40 of the DMDs 36, and supplies the resolution-converted test data to the output data processor 76. The output data processor 76 processes the resolution-converted test data into test output data representing signals for selectively turning on and off the micromirrors 40, and supplies the test output data to the output data corrector 78. The output data corrector 78 forcibly turns off those test output data for the micromirrors 40 which correspond to the initial mask data supplied from the mask data memory 82, and then supplies the corrected test output data to the DMD controller 42.

The DMD controller 42 selectively turns on and off the micromirrors 40 of the DMDs 36 according to the test output data that have been corrected by the initial mask data, thereby applying the laser beams L emitted from the light source units 28a through 28j to the substrate F to record a test pattern, by way of exposure, on the entire surface of the substrate F (step S6). Since the test pattern is formed according to the test output data that have been corrected by the initial mask data, the test pattern is free of the amount-of-light locality of the laser beams L in the direction indicated by the arrow x at the time the photosensor 68 measures the amounts of light of the laser beams L.

After the substrate F with the recorded test pattern is removed from the exposure stage 18, the processing apparatus performs the developing process, the etching process, and the resist peeling process on the substrate F, producing the substrate F with the test pattern remaining thereon (step S7).

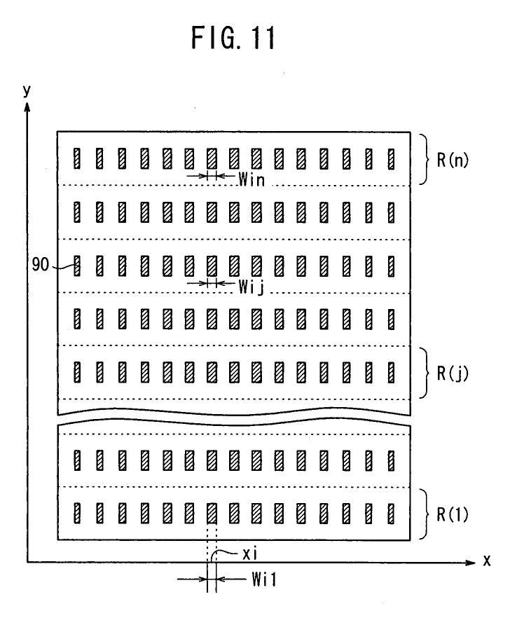

As shown in FIG. 11, for example, the test pattern is divided into n regions R(1), . . . , R(j), . . . , R(n) in the direction indicated by the arrow y, i.e., the direction in which the substrate F moves, with a plurality of rectangular patterns 90 being formed at respective positions xi spaced along the direction indicated by the arrow x in each of the regions R(1) through R(n). If the rectangular pattern 90 at the position xi in the region R(j) has a line width Wij in the direction indicated by the arrow x, then the test output data are established such that the line width Wij remains constant regardless of the position xi and the region R(j) in an ideal state that is free of localities in the directions indicated by the arrows x, y.

The line widths Wij (i=1, 2, . . . , j=1 through n) of the rectangular patterns 90 on the substrate F are measured (step S8), and the measured result is supplied as line width data to the mask data setting unit 86.

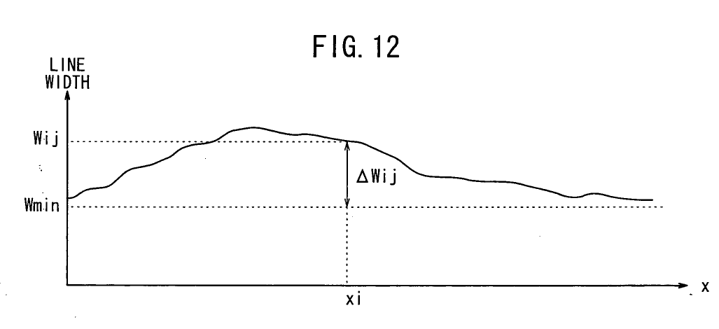

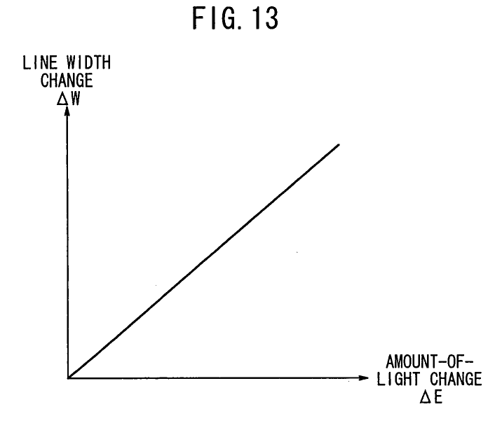

FIG. 12 shows the relationship between the positions xi in the direction indicated by the arrow x and the line widths Wij measured in the regions R(j). FIG. 13 shows the relationship between changes ΔE in the amount of light of the laser beam L applied to the substrate F and corresponding line width changes ΔW. This relationship is determined in advance by an experiment using the photosensitive material, to be exposed, applied to the substrate F, and stored in the amount-of-light/line width table memory 87.

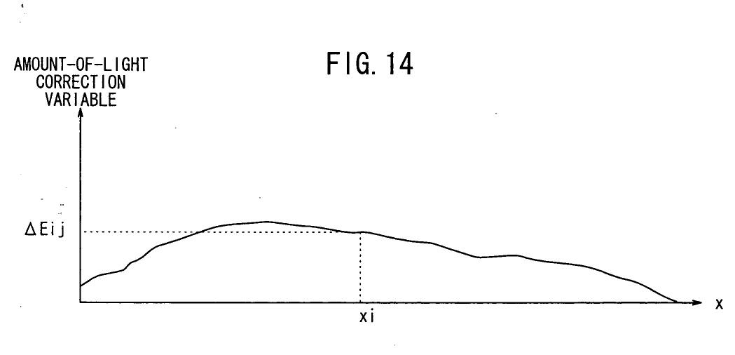

The mask data setting unit 86 reads the amount-of-light/line width table from the amount-of-light/line width table memory 87, and calculates amount-of-light correction variables ΔEij at the positions xi in the respective regions R(j) for obtaining line width correction variables ΔWij with which to correct the line widths Wij into a minimum line width Wmin, using the relationship between the amount-of-line changes ΔE and the line width changes ΔW (step S9, see FIG. 14).

Based on the calculated amount-of-light correction variables ΔEij, the mask data setting unit 86 adjusts the initial mask data set in step S4 to establish mask data for the respective regions R(j) (step S10). The mask data are established as data for determining micromirrors 40 to be secured to the off-state among the micromirrors 40 that are used to form one pixel of image at each position xi on the substrate F, according to the amount-of-light correction variables ΔEij. The established mask data are stored, in place of the initial mask data, in the mask data memory 82 (step S11).

Specifically, the mask data may be established as follows: Using the proportion of an amount-of-light correction variable ΔEij to an amount Ei of light (see FIG. 6) at the time the output data are corrected with the initial mask data, and the number N of micromirrors 40 for forming one pixel, the number n of micromirrors 40 to be secured to the off-state is calculated by:

n=N·ΔEij/Ei

### The mask data are established to set the n micromirrors, among the N micromirrors, to the off-state.

If the widths of the regions R(1) through R(n) of the test pattern shown in FIG. 11 are large in the direction indicated by the arrow y and the micromirrors 40 to be secured to the off-state are arrayed in the direction indicated by the arrow y, then striped irregularities may possibly occur in the direction in which the recorded image is scanned, i.e., the direction indicated by the arrow y. In order to avoid the drawback, it is desirable to shift the positions of the micromirrors 40 to be secured to the off-state in the direction indicated by the arrow x insofar as the correction of the locality in the direction indicated by the arrow x will not be adversely affected.

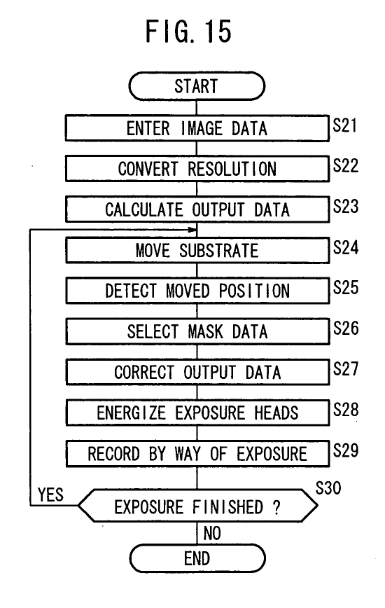

After the mask data have thus been established, a desired wiring pattern is recorded by way of exposure on the substrate F. An exposure recording process performed by the exposure apparatus 10 will be described below with reference to a flowchart shown in FIG. 15.

First, image data representing a desired wiring pattern are entered from image data input unit 70 (step S21). The entered image data are stored in the frame memory 72, and then supplied to the resolution converter 74. The resolution converter 74 converts the resolution of the image data into a resolution depending on the resolution of the DMDs 36, and supplies the resolution-converted image data to the output data processor 76 (step S22). The output data processor 76 calculates output data representing signals for selectively turning on and off the micromirrors 40 of the DMDs 36 from the resolution-converted image data, and supplies the calculated output data to the output data corrector 78 (step S23).

Then, the exposure stage 18 with the substrate F placed thereon starts moving in the direction indicated by the arrow y (step S24), and a position to which the exposure stage 18 has moved is detected by the encoder 85 (step S25).

Based on the detected moved position of the substrate F in the direction indicated by the arrow y, the mask data selector 83 selects mask data established for the region R(1) corresponding to the moved position from the mask data memory 82 (step S26), and supplies the selected mask data to the output data corrector 78.

The output data corrector 78 corrects the on- and off-states of the micromirrors 40 that are represented by the output data, using the mask data established for the region R(1) and supplied from the mask data memory 82, and supplies the corrected output data to the DMD controller 42.

The DMD controller 42 energizes the DMDs 36 based on the corrected output data to selectively turn on and off the micromirrors 40 (step S28). The laser beams L emitted from the light source units 28a through 28j and introduced through the optical fibers 30 into the exposure heads 24a through 24j are applied via the rod lenses 32 and the reflecting mirrors 34 to the DMDs 36. The laser beams L selectively reflected in desired directions by the micromirrors 40 of the DMDs 36 are magnified by the first image focusing optical lenses 44, 46, and then adjusted to a predetermined beam diameter by the microaperture arrays 54, the microlens arrays 48, and the microaperture arrays 56. Thereafter, the laser beams L are adjusted to a predetermined magnification by the second image focusing optical lenses 50, 52, and then guided to the substrate F. The exposure stage 18 moves along the bed 14, during which time a wiring pattern having a desired line width for the region R(1) in the direction indicated by the arrow x is recorded on the substrate F by the exposure heads 24a through 24j that are arrayed in the direction perpendicular to the direction in which the exposure stage 18 moves (step S29).

If the encoder 85 detects when the substrate F has moved to the region R(2) (steps S30, S25), the mask data selector 83 selects mask data established for the region R(2) from the mask data memory 82, and supplies the selected mask data to the output data corrector 78 (step S26). Then, a wiring pattern for the region R(2) is recorded on the substrate F in the same manner as described above (steps S27 through S30). The above process is repeated up to the region R(n) on the substrate F to record a wiring pattern having a desired line width on the entire surface of the substrate F.

After the desired wiring pattern has been recorded on the substrate F, the substrate F is removed from the exposure apparatus 10, and then the developing process, the etching process, and the resist peeling process are performed on the substrate F.

The amount of light of the laser beam L applied to the substrate F has been corrected using the mask data established in view of the processes up to the final peeling process, such that the line widths Wij in the direction indicated by the arrow x of the rectangular patterns 90 shown in FIG. 11 are constant regardless of the exposed positions in the direction indicated by the arrow x. Therefore, it is possible to obtain a wiring pattern having a desired line width in the direction indicated by the arrow x.

Furthermore, in view of the locality produced with respect to the direction in which the substrate F moves, the mask data is changed for each of the regions R(1) through R(n) to keep the line widths Wij in the direction indicated by the arrow x of the rectangular patterns 90 shown in FIG. 11, constant between the regions R(1) through R(n). Consequently, it is also possible to obtain a wiring pattern having a desired line width at each exposed position in the direction indicated by the arrow y.

In the above embodiment, the rectangular patterns 90 shown in FIG. 11 are recorded on the substrate F by way of exposure, and the mask data are determined by measuring the line widths Wij. However, mask data may be determined by measuring intervals between adjacent ones of the rectangular patterns 90. If it is difficult to measure the line widths Wij or the intervals highly accurately, then small areas may be established around the respective positions xi of the rectangular patterns 90, the densities of the small areas may be measured, and mask data may be determined from a distribution of the measured densities.

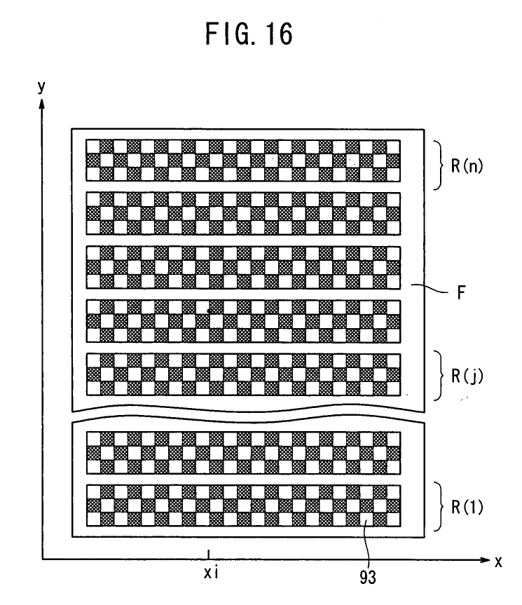

Instead of recording the rectangular patterns 90 on the substrate F by way of exposure, as shown in FIG. 16, halftone dot patterns 93 extending in the direction indicated by the arrow x and having a predetermined halftone dot % may be recorded respectively in the regions R(1) through R(n) on the substrate F by way of exposure, and mask data may be determined by measuring halftone dot % or densities in respective small areas established around the respective positions xi.

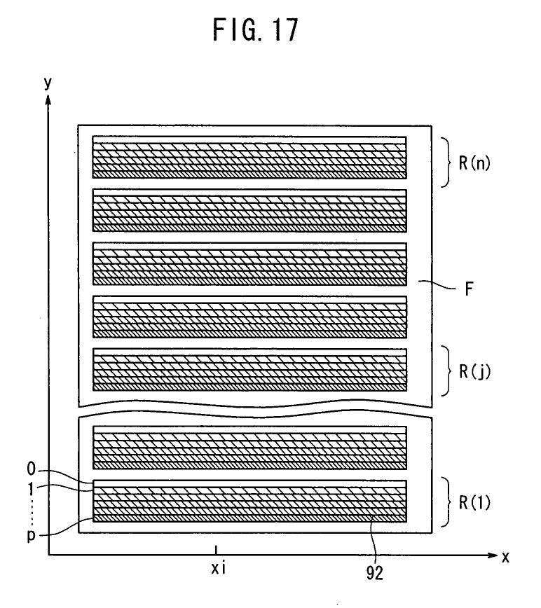

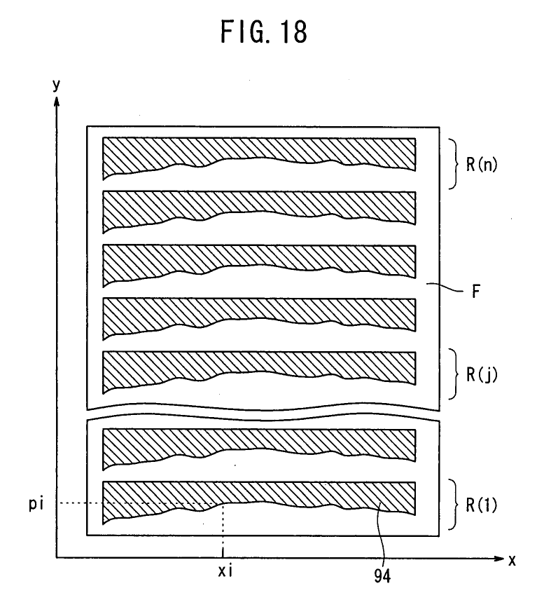

Gray scale data in p (p=1, 2, . . . ) steps for incrementing the amount of light of the laser beam L stepwise may be set as test data in the test data memory 80, and using the gray scale data, as shown in FIG. 17, gray scale patterns 92 extending in the direction indicated by the arrow x and depending on amounts of light which change stepwise in the direction indicated by the arrow y are recorded respectively in the regions R(1) through R(n) on the substrate F by way of exposure. Thereafter, the substrate F may be developed, and then, as shown in FIG. 18, the widths in the direction indicated by the arrow y at respective positions xi of resist patterns 94 remaining on the substrate F are measured in the respective regions R(1) through R(n). The number pi of corresponding steps of the gray scale pattern 92 at the positions xi on the resist patterns 94 may be determined, and mask data may be determined based on the number pi.

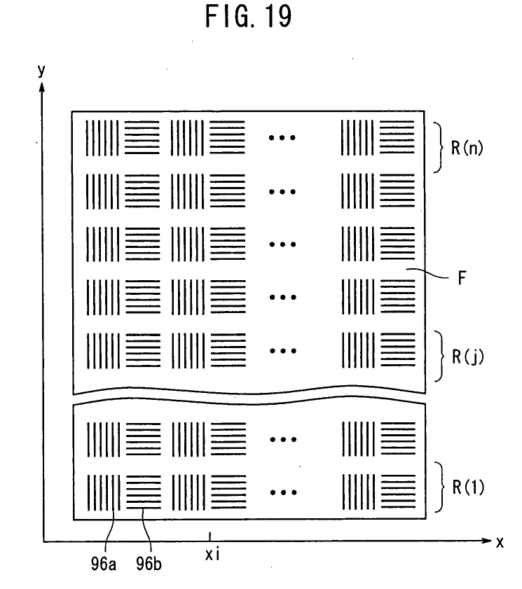

Alternatively, mask data may be determined by measuring the line widths of test patterns arrayed in two different directions. For example, as shown in FIG. 19, a grid-like pattern 96a of bars extending parallel to each other along the scanning direction, i.e., the direction indicated by the arrow y, and grid-like pattern 96b of bars extending parallel to each other along the direction perpendicular to the scanning direction, i.e., the direction indicated by the arrow x, may be recorded as a set at each of the positions xi in the regions R(1) through R(n) on the substrate F, and amount-of-light correction variables may be calculated based on the average of the line widths of the grid-like patterns 96a, 96b to determine mask data for the regions R(1) through R(n). Using the test patterns arrayed in such two different directions, factors that are responsible for varying the line widths depending on the directions of the test patterns can be eliminated.

Furthermore, test patterns are not limited to the grid-like patterns 96a, 96b arrayed in the two directions, but may be grid-like patterns arrayed in three or more directions. Alternatively, grid-like patterns inclined to the directions indicated by the arrows x, y may be employed. Further alternatively, prescribed circuit patterns may be formed as test patterns, and the amount of light of the laser beam may be corrected by measuring the circuit patterns.

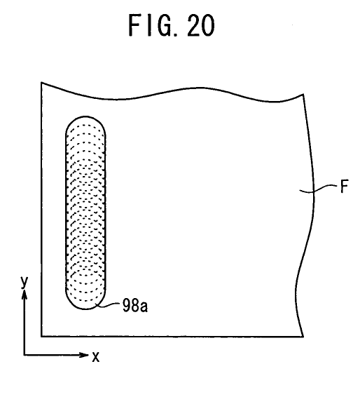

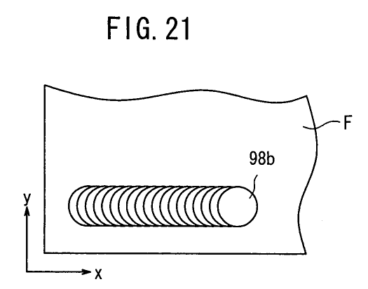

One factor that is responsible for varying the line widths may be that an edge of a test pattern is recorded differently in the direction in which the substrate F moves and the direction perpendicular to the direction in which the substrate F moves. Specifically, as shown in FIG. 20, an edge 98a of a test pattern in the direction in which the substrate F moves, i.e., the direction indicated by the arrow y, is recorded by a single spot or a plurality of spots of the laser beam L that move in the direction indicated by the arrow y, i.e., the direction in which the substrate F moves. On the other hand, as shown in FIG. 21, an edge 98b of a test pattern in the direction indicated by the arrow x is recorded by a plurality of spots of the laser beam L that do not move relatively to the substrate F. The difference as to how the edges 98a, 98b are recorded is possibly liable to develop different line widths. There is also a possibility of different line widths if the spots of the laser beam L are not of a circular shape. By establishing mask data in view of such direction-depending line width variations, it is possible to obtain a wiring pattern with higher accuracy.

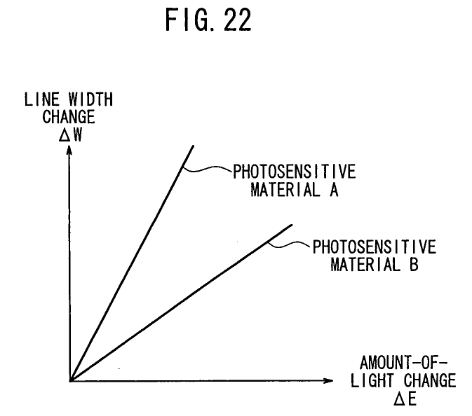

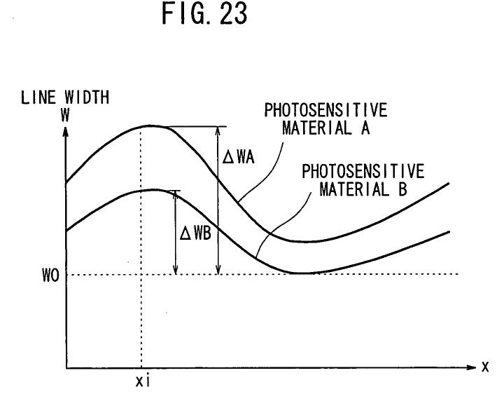

Alternatively, mask data may be established by determining an amount-of-line correction variable depending on the type of the photosensitive material applied to the substrate F. Specifically, as shown in FIG. 22, the relationship between a change ΔE in the amount of light of the laser beam L applied to the substrate F and a change ΔW in the corresponding line width, or the relationship between the beam diameter of the laser beam L and a change ΔW in the corresponding line width, differ depending on the types of photosensitive materials A, B. The different relationships are caused by different gradation characteristics of the photosensitive materials A, B. As shown in FIG. 23, different line widths W may be produced even when a test pattern is recorded on the photosensitive materials A, B under the same conditions. In FIG. 22, the relationship between the change ΔE in the amount of light of the laser beam L and the change ΔW in the corresponding line width is approximated by a straight line.

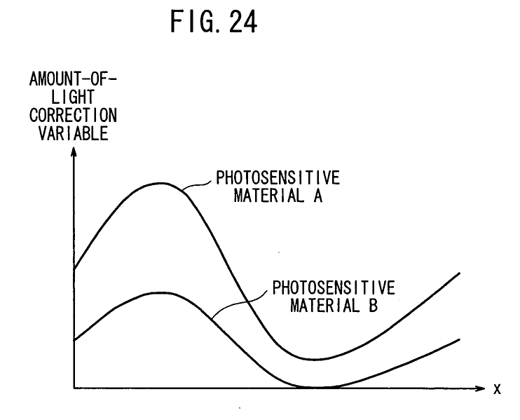

For recording patterns of the same line width regardless of the different characteristics of the photosensitive materials A, B, it is necessary to establish amount-of-light correction variables depending on the photosensitive materials A, B from the characteristic curves (FIG. 22) of the photosensitive materials A, B with respect to the relationship between the change ΔE in the amount of light of the laser beam L and the change ΔW in the corresponding line width, and changes ΔWA, ΔWB (FIG. 23) from a reference line width W0 (e.g., a minimum value of the line width W) at each position xi for the respective photosensitive materials A, B. FIG. 24 shows an example of amount-of-light correction variables established for the photosensitive materials A, B.

The mask data setting unit 86 sets mask data based on the amount-of-light correction variables in the regions R(1) through R(n) that are determined for the photosensitive materials A, B, and stores the established mask data in the mask data memory 82. For exposing the substrate F to a desired wiring pattern, mask data corresponding to the type of the photosensitive material entered by the operator are read from the mask data memory 82, and output data supplied from output data processor 76 are corrected by the mask data. In this manner, a highly accurate wiring pattern free of line width variations can be recorded on the substrate F by way of exposure, independently of the type of the photosensitive material.

Mask data for correcting a locality in the direction indicated by the arrow x can also be generated as follows:

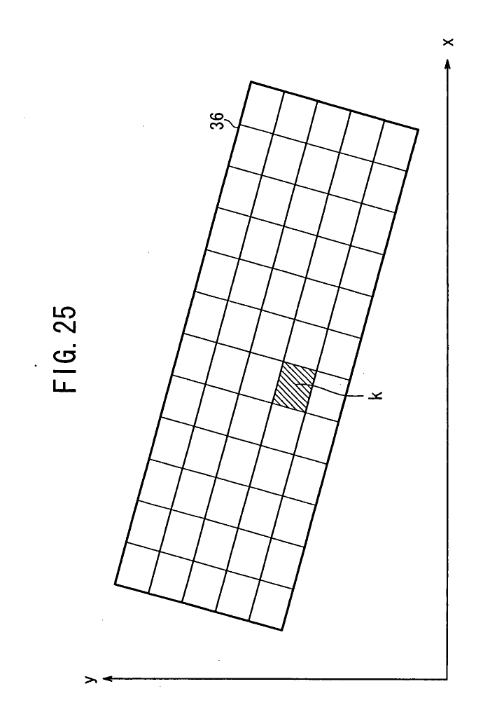

FIG. 25 shows each of the DMDs 36 disposed in the exposure heads 24a through 24j, as divided into a plurality of areas K comprising a plurality of adjacent micromirrors 40. An amount E_{K} of light of a laser beam L output from each of the areas K is measured by the photosensor 68. The amount E_{K} of light can be measured by turning on only the micromirrors on the area K and moving the photosensor 68 to a position directly beneath each of the areas K.

The measured amount E_{K} of light of the laser beam L output from each of the areas K is supplied to the amount-of-light locality calculator 88, which compares the supplied amount E_{K} of light with a reference amount Es of light, thereby calculating an amount-of-light locality data in each of the areas K. The calculated amount-of-light locality data are supplied to the mask data setting unit 86. The mask data setting unit 86 generates mask data for converting supplied amount-of-light locality data into the reference amount Es of light. Using the mask data thus generated, a locality of the amount of light in the direction indicated by the arrow x can be corrected. The mask data thus generated may be established as the initial mask data in step S4.

The light source units 28a through 28j of the exposure heads 24a through 24j may be controlled by a light source controller 89 (see FIG. 9), and after a locality of the amount of light, as detected by the photosensor 68, of each of the laser beams L emitted from the light source units 28a through 28j is corrected, mask data for correcting a locality in the direction indicated by the arrow x may be generated. The amounts of light of the laser beams L emitted from the light source units 28a through 28j may be adjusted as follows: The light widths Wij in the direction indicated by the arrow x of the rectangular patterns 90 corresponding to the respective positions of the light source units 28a through 28j are measured, and amount-of-light correction variables for equalizing the line widths Wij are calculated using the table stored in amount-of-light/line width table memory 87. Then, the amounts of light of the laser beams L emitted from the light source units 28a through 28j are adjusted by the light source controller 89 according to the amount-of-light correction variables.

The exposure apparatus 10 with the mask data set therein as described above tends to suffer as time-dependent changes in the amounts of light of the laser beams L due to degradation and temperature fluctuations of the light source units 28a through 28j, time-dependent changes in dot sizes caused by defocusing due to variations of the mounted positions of the optical systems, time-dependent changes in the sensitivity of the image recording medium, and time-dependent changes in processed states in the processing sequence such as the developing process. Therefore, an adjusting process should preferably be carried out for the exposure apparatus 10 in view of the above time-dependent changes.

For example, when mask data are generated, the amount-of-light locality data calculated by the amount-of-light locality calculator 88 are stored in an amount-of-light locality data memory 91 (see FIG. 9). For adjusting mask data in view of time-dependent changes in the amounts of light of the laser beams L, the amounts of light of the laser beams L emitted from the light source units 28a through 28j are measured by the photosensor 68. After the amount-of-light locality calculator 88 calculates amount-of-light locality data, the mask data setting unit 86 corrects the mask data using the amount-of-light locality data in the present cycle and the amount-of-light locality data in the preceding cycle read from the amount-of-light locality data memory 91.

Specifically, the difference between the amount-of-light locality data in the present cycle and the amount-of-light locality data in the preceding cycle is determined as a time-dependent change in the amounts of light, and the presently established mask data are corrected to correct the time-dependent change in the amounts of light. As a result, the mask data corrected in view of the time-dependent change in the amounts of light can easily be generated without the need for a complex process of generating the test patterns shown in FIG. 11. In this case, the mask data setting unit 86, the amount-of-light locality calculator 88, and the amount-of-light locality data memory 91 functions as a mask data corrector for calculating a change in the amount-of-light locality and correcting mask data according to the calculated change in the amount-of-light locality.

For adjusting mask data in view of time-dependent changes in the amounts of light due to temperature fluctuations, the temperature in the exposure apparatus 10 or the temperature of each of the exposure heads 24a through 24j is measured when the mask data are generated. Then, after elapse of a predetermined time, the temperature is measured again, and a change of the temperature measured in the present cycle from the temperature measured in the preceding cycle is determined as a time-dependent change in the temperature. Based on the time-dependent change in the temperature, the mask data determined in the preceding cycle are corrected. In this manner, the mask data can be adjusted in view of time-dependent changes in the amounts of light due to temperature fluctuations.

For adjusting mask data in view of time-dependent changes in dot sizes caused by defocusing due to variations of the mounted positions of the optical systems, the beam diameter of each of the laser beams L is measured when the mask data are generated. Then, after elapse of a predetermined time, the beam diameter of each of the laser beams L is measured again, and a change of the beam diameter measured in the present cycle from the beam diameter measured in the preceding cycle is determined as a time-dependent change in the beam diameter. Based on the time-dependent change in the beam diameter, the mask data determined in the preceding cycle are corrected. In this manner, the mask data can be adjusted in view of time-dependent changes in dot sizes.

For adjusting mask data in view of time-dependent changes in the sensitivity of the image recording medium and time-dependent changes in processed states in the processing sequence, the difference between line width data obtained from a test pattern generated when the mask data are generated in the preceding cycle and line width data obtained from a test pattern generated when the mask data are generated in the present cycle upon elapse of a predetermined time from the preceding cycle, is determined as a time-dependent change in the line width data. Based on the time-dependent change in the line width data, the mask data determined in the preceding cycle are corrected. In this manner, the mask data can be adjusted in view of time-dependent changes in the sensitivity of the image recording medium and time-dependent changes in processed states in the processing sequence.

The light source units 28a through 28j of the exposure apparatus 10 may comprise a two-dimensional array of semiconductor lasers, solid-state lasers, light-emitting devices, or the like, or a combination of a light source such as laser diode or the like and an optical fiber array in the form of a two-dimensional array of optical fibers.

A spatial light modulator for guiding optical beams to an image recording medium may be employed instead of the DMDs. Such a spatial light modulator may be an LCD (Liquid Crystal Display), a spatial light modulator of PLZT (Plomb Lanthanum Zirconate Titanate), a GLV (Grating Light Valve), or the like.

The exposure apparatus 10 may appropriately be used to expose a dry film resist (DFR) in a process of manufacturing a printed wiring board (PWB), to form a color filter in a process of manufacturing a liquid crystal display (LCD), to expose a DFR in a process of manufacturing a TFT, and to expose a DFR in a process of manufacturing a plasma display panel (PDP), etc., for example.

The present invention is also applicable to an image recording apparatus having an ink jet recording head. The present invention is also applicable to exposure apparatus for use in the field of printing and the field of photography.

The scanning exposure process which may be employed in the exposure apparatus 10 may be a flat-bed scanning process, an external-drum scanning process, an internal-drum scanning process, or the like.

Although certain preferred embodiments of the present invention have been shown and described in detail, it should be understood that various changes and modifications may be made therein without departing from the scope of the appended claims.

What is claimed is:

1. A method of recording an image on an image recording medium by moving a plurality of recording elements controlled depending on image data, with respect to the image recording medium in a direction, comprising the steps of:
establishing mask data for controlling selected ones of said recording elements to be brought into an off-state in order to correct a locality of image quality which appears in said direction, said mask data being dependent on a moved position of said recording elements in said direction; and
controlling said recording elements based on said image data which determine on- and off-states of said recording elements and said mask data which determine the off-state of said recording elements for thereby recording an image on said image recording medium.

2. A method according to claim 1, wherein said locality appears due to a locality with respect to recording energy applied to said image recording medium by said recording elements, dot sizes formed on said image recording medium by said recording elements, sensitivity of said image recording medium, a temperature of said image recording medium, or a processing sequence for processing said image recording medium with an image recorded thereon.

3. A method according to claim 1, wherein said mask data, which control said selected ones of said recording elements to be brought into the off-state and which are dependent on moved positions of said recording elements in said direction and a perpendicular direction which is perpendicular to said direction, are established in order to correct localities of image quality which appear in said direction and said perpendicular direction.

4. A method according to claim 1, further comprising the steps of:
determining a time-dependent change in said locality; and
correcting said mask data according to said time-dependent change in said locality.

5. A method according to claim 1, further comprising the steps of:
recording a test pattern on said image recording medium based on test data; and
establishing said mask data in order to correct said locality which appears in said test pattern.

6. An apparatus for recording an image on an image recording medium by moving a plurality of recording elements controlled depending on image data, with respect to the image recording medium in a direction, comprising:
a mask data storage unit for storing mask data for controlling selected ones of said recording elements to be brought into an off-state in order to correct a locality of image quality which appears in said direction, said mask data being dependent on a moved position of said recording elements in said direction;
a mask data selector for selecting said mask data depending on said moved position from said mask data storage unit; and
a recording element controller for controlling said recording elements based on said image data which determine on- and off-states of said recording elements and said selected mask data which determine the off-state of said recording elements.

7. An apparatus according to claim 6, wherein said recording elements make up an exposure device for guiding a light beam depending on said image data to said image recording medium to record an image on said image recording medium by exposing said image recording medium to said light beam.

8. An apparatus according to claim 7, wherein said exposure device comprises a spatial light modulator for modulating a light beam applied thereto with said image data and guiding the modulated light beam to said image recording medium.

9. An apparatus according to claim 8, wherein said spatial light modulator comprises a micromirror device having a two-dimensional array of micromirrors serving as said recording elements which have reflecting surfaces for reflecting said light beam, said reflecting surfaces having an angle variable according to said image data.

10. An apparatus according to claim 6, wherein said mask data storage unit stores mask data for correcting localities of image quality which appear in said direction and a perpendicular direction which is perpendicular to said direction.

11. An apparatus according to claim 6, wherein said mask data storage unit stores said mask data depending on the type of said image recording medium.

12. An apparatus according to claim 6, further comprising:
a test data storage unit for storing test data for recording a test pattern on said image recording medium; and
a mask data establishing unit for establishing said mask data in order to correct said locality which appears in said test pattern recorded on said image recording medium.

13. An apparatus according to claim 6, wherein said locality appears due to a locality with respect to recording energy applied to said image recording medium by said recording elements, dot sizes formed on said image recording medium by said recording elements, sensitivity of said image recording medium, a temperature of said image recording medium, or a processing sequence for processing said image recording medium with an image recorded thereon.

14. An apparatus according to claim 6, further comprising a mask data corrector for determining a time-dependent change in said locality and correcting said mask data according to said time-dependent change in said locality.
